(19) United States
(12) Patent Application Publication
(10) Pub. No.: US 2026/0287282 A1
(43) Pub. Date: Sep. 24, 2026

(54) MANIFOLD-INTEGRATED COOLANT MODULE

(71) Applicant: HYUNDAI WIA Corporation, Changwon-si (KR)

(72) Inventors: Dong Hyeon KIM, Uiwang-si (KR); Sang Min LEE, Uiwang-si (KR)

(73) Assignee: HYUNDAI WIA Corporation, Changwon-si (KR)

(21) Appl. No.: 19/569,256

(22) Filed: Mar. 17, 2026

(30) Foreign Application Priority Data
Mar. 20, 2025 (KR) 10-2025-0035858

(51) Int. Cl. F28F 9/02; B60K 11/04; F28F 9/00; F28F 9/007

(52) U.S. Cl. CPC F28F 9/0275; B60K 11/04; F28F 9/005; F28F 9/0075

(57) ABSTRACT

Disclosed is a manifold-integrated coolant module. The manifold-integrated coolant module includes a valve body including a rotor space defined in the valve body and a valve housing having at least one port provided along a circumference of the valve housing, a manifold disposed on one side of the valve body, and a heat exchanger disposed on one side of the manifold. The heat exchanger, the manifold, and the valve body are coupled in fluid communication with one another, and the manifold is integrally formed with the valve body.

### CROSS-REFERENCE TO THE RELATED APPLICATION

The present application claims priority to and the benefit of Korean Patent Application No. 10-2025-0035858, filed on Mar. 20, 2025, in the Korean Intellectual Property Office, the entire disclosure of which is incorporated herein by reference.

### BACKGROUND

### 1. Field

The present disclosure relates to a manifold-integrated coolant module.

### 2. Description of the Related Art

As electric vehicles have recently become widely distributed, technologies related thereto have been developed. Such an electric vehicle is configured to be driven by operating a driving motor using electrical energy stored in a battery. A battery or electric components of an electric vehicle need to be thermally managed. However, unlike internal combustion engine vehicles, electric vehicles do not include an engine. Therefore, in electric vehicles, thermal management is performed using electrical energy, rather than using an engine as a heat source.

A current thermal management system of electric vehicles includes a plurality of pipes through which refrigerant and coolant flow and various types of valves configured to change or open/close flow paths of the pipes. However, the pipes and the valves are connected to one another in a complicated manner. Therefore, the overall thermal management system becomes large in size and difficult to assemble, and large numbers of components such as pipes and valves are required, resulting in increase in manufacturing cost and weight of the thermal management system.

The information disclosed in this section is only for enhancement of understanding of the background of the disclosure, and should not be taken as an acknowledgement or any form of suggestion that this information forms the related art already known to a person skilled in the art.

### SUMMARY

The present disclosure has been made in view of the above-described issues, and an aspect of the present disclosure is to provide a manifold-integrated coolant module having a novel structure, in which coolant-related components of a thermal management system are modularized to make a coolant circuit compact and to reduce weight and manufacturing cost of the coolant module.

A manifold-integrated coolant module according to an embodiment of the present disclosure for accomplishing the above aspect includes a valve body including a valve housing having a rotor space defined therein and at least one port provided along a circumference of the valve housing, a manifold disposed on one side of the valve body, and a heat exchanger disposed on one side of the manifold. The heat exchanger, the manifold, and the valve body are coupled in fluid communication with one another, and the manifold is integrally formed with the valve body.

The manifold may include a manifold housing including a coolant flow space defined in the manifold housing and a manifold cover covering an open surface of the coolant flow space of the manifold housing. A first partition wall may be provided in the coolant flow space to partition the coolant flow space into a first space defined between one side of the manifold housing and the first partition wall and a space defined between the first partition wall and the other side of the manifold housing, and the first space may be an independent space.

A second partition wall may be provided in the space defined between the first partition wall and the other side of the manifold housing to partition the space defined between the first partition wall and the other side of the manifold housing into a second space defined between the other side of the manifold housing and the second partition wall and a third space defined between the first partition wall and the second partition wall, and the second space may be an independent space.

The manifold housing may include a manifold inlet port provided at one side of the manifold housing, and the manifold inlet port may be in fluid communication with the first space through an inlet hole formed in one side of the manifold housing.

The manifold housing may include a manifold outlet port provided at the other side of the manifold housing, and the manifold outlet port may be in fluid communication with the second space through an outlet hole formed in the other side of the manifold housing.

The manifold-integrated coolant module may further include a communication hole formed through the valve housing and the manifold housing to allow the valve body and the manifold to be in fluid communication with each other through the communication hole, and the communication hole may be oriented perpendicular to a bottom surface of the manifold housing and may extend toward the valve housing.

A guide wall may be provided between the inlet hole and the communication hole in the first space to block a region between the inlet hole and the communication hole.

The first space may be divided into an inlet hole-side space and a communication hole-side space by the guide wall. The guide wall may extend from an upper wall of the manifold housing toward a lower wall of the manifold housing, and an end of the guide wall may be spaced apart from the lower wall to define a connection passage fluidly connecting the inlet hole-side space to the communication hole-side space.

The manifold-integrated coolant module may further include a valve rotor disposed in the rotor space, an actuator mounted on a lower side of the valve body to drive the valve rotor, and a support bracket supporting the valve body upwardly.

The manifold may be coupled to the support bracket in an upright orientation such that the coolant flow space is disposed in a vertical direction.

The inlet hole and the outlet hole may be disposed at an upper portion of the manifold housing and the connection passage may be disposed at a lower portion of the manifold housing such that coolant introduced into the inlet hole-side space through the inlet hole flows downward toward the connection passage and coolant introduced into the communication hole-side space via the connection passage flows upward within the communication hole-side space.

The communication hole-side space may include a valve outlet space and a heat exchanger outlet space disposed in a coolant flow direction, and the valve outlet space may be positioned below the heat exchanger outlet space such that the coolant passes through the valve outlet space and then passes through the heat exchanger outlet space.

The manifold cover may sealingly cover the entirety of an open surface of the manifold housing and may include a first port provided at a position corresponding to the heat exchanger outlet space, and the heat exchanger may include a coolant inlet and a coolant outlet. If the heat exchanger is coupled to one side of the manifold, the coolant inlet may be coupled to the first port.

The manifold-integrated coolant module may further include a second port provided at a position corresponding to the second space, and the heat exchanger may include a coolant inlet and a coolant outlet. If the heat exchanger is coupled to one side of the manifold, the coolant outlet may be sealingly coupled to the second port.

The communication hole may be disposed in the valve outlet space, and the first port may be disposed in the heat exchanger outlet space.

Opening/closing of the communication hole may be controlled according to a rotational angle of the valve rotor. If the communication hole is open, coolant having passed through the connection passage may flow into the rotor space through the communication hole, and if the communication hole is closed, the coolant may flow into the valve outlet space and the heat exchanger outlet space and then may flow into the coolant inlet of the heat exchanger through the first port.

The heat exchanger may include a T-shaped branch pipe for inflow and outflow of coolant, and the T-shaped branch pipe may be integrally coupled to the heat exchanger by means of a central connection pipe.

The manifold-integrated coolant module may further include a support bracket supporting the valve body upwardly. The heat exchanger may be coupled to the support bracket in an upright orientation such that refrigerant and coolant flow in the vertical direction and may include a refrigerant inlet port, a refrigerant outlet port, a coolant inlet, and a coolant outlet. The coolant outlet may be disposed at an upper portion of the heat exchanger, and the refrigerant outlet port may be disposed at a lower portion of the heat exchanger.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view of a coolant module according to an embodiment of the present disclosure;

FIG. 2 is a plan view of the coolant module shown in FIG. 1;

FIG. 3 is a perspective view showing a state in which a valve body, a manifold, and a heat exchanger are coupled in the coolant module according to the embodiment of the present disclosure;

FIG. 4 is an exploded perspective view of the coolant module shown in FIG. 3;

FIGS. 5A and 5B are perspective views showing a configuration in which the valve body and the manifold are integrally formed in the coolant module according to the embodiment of the present disclosure as viewed from different angles;

FIG. 6 is a perspective view showing a state in which a manifold housing is coupled to the valve body shown in FIG. 4;

FIG. 7 is a perspective view showing a state in which a manifold cover is coupled to the manifold housing shown in FIG. 6;

FIG. 8 is a perspective view showing a state in which the heat exchanger is coupled to the manifold shown in FIG. 7; and

FIG. 9 is a perspective view of the heat exchanger shown in FIG. 8 as viewed from another angle.

### DETAILED DESCRIPTION OF EXEMPLARY EMBODIMENTS

Hereinafter, exemplary embodiments of the present disclosure will be described in detail with reference to the accompanying drawings. Embodiments of the present disclosure are provided to more fully illustrate the disclosure to a person having ordinary skill in the art, and the following embodiments may be modified in various other forms, and the scope of the disclosure is not limited to the following embodiments. The embodiments are provided to make the disclosure more faithful and complete and to completely convey the idea of the disclosure fully to those skilled in the art.

In the following drawings, the thickness or size of each layer is exaggerated for convenience and clarity of description, and same reference numerals in the drawings refer to the same elements. As used herein, the term “and/or” includes any one of the enumerated items and any combination of one or more thereof. As used herein, the term “connected” refers not only to direct connection between members A and B but also to indirect connection between members A and B with member C interposed therebetween. The terms used in the specification are intended to describe specific embodiments and are not intended to limit the disclosure. As used herein, singular forms may include plural forms, unless the context clearly indicates otherwise. As used herein, the terms “comprise” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups thereof.

While terms such as “first” and “second” are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath,” “below,” “lower,” “above,” and “upper,” may be utilized to facilitate understanding of one element or feature shown in the drawings as different from another element or feature. The terms related to space are intended to facilitate understanding of the disclosure in various states of process or use and are not intended to limit the disclosure. For example, if an element or feature in a figure is inverted, an element or feature described as “beneath” or “below” becomes “above” or “upper.” Thus, “beneath” is a concept that encompasses “above” or “below.”

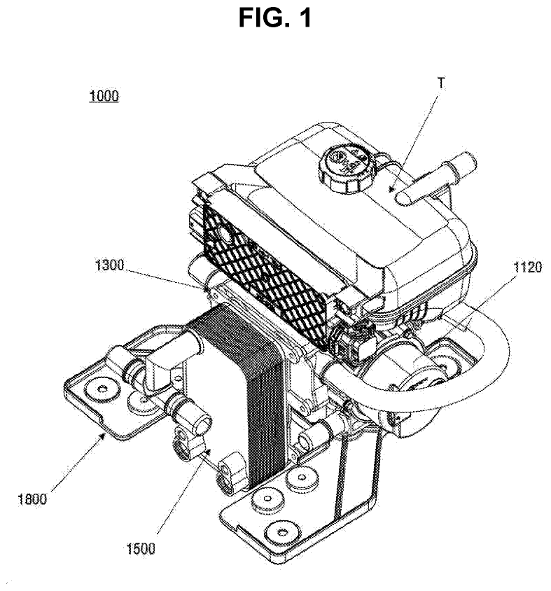

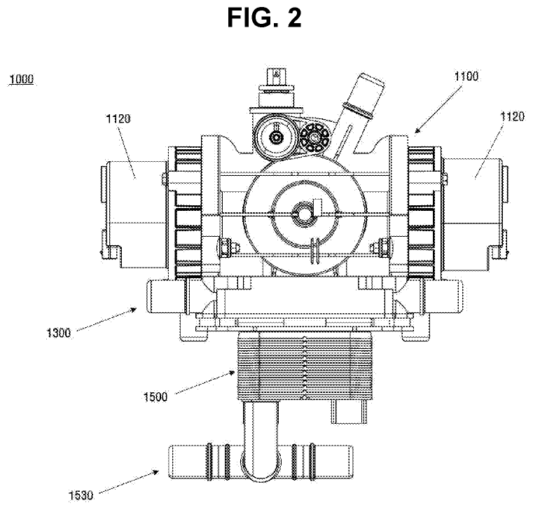

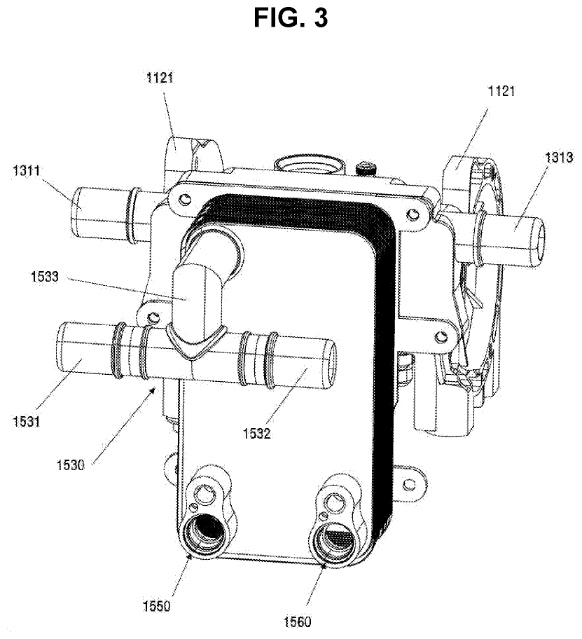

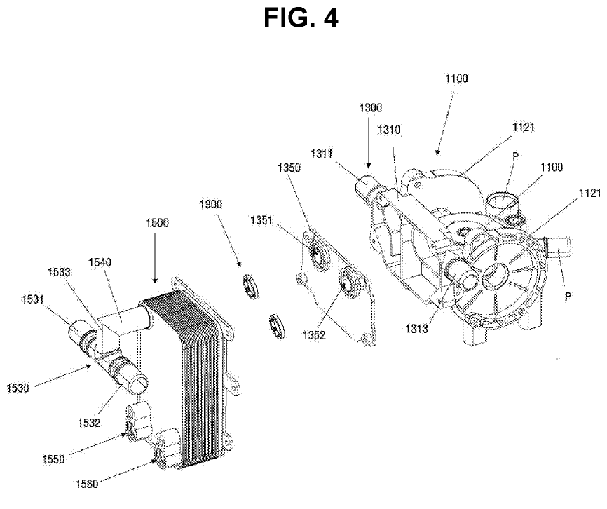

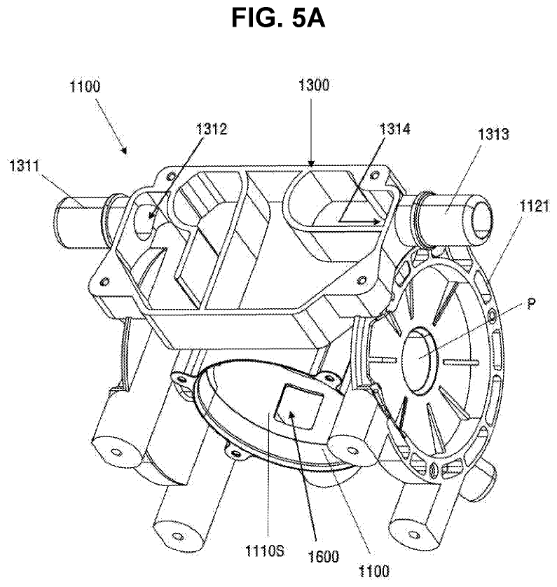

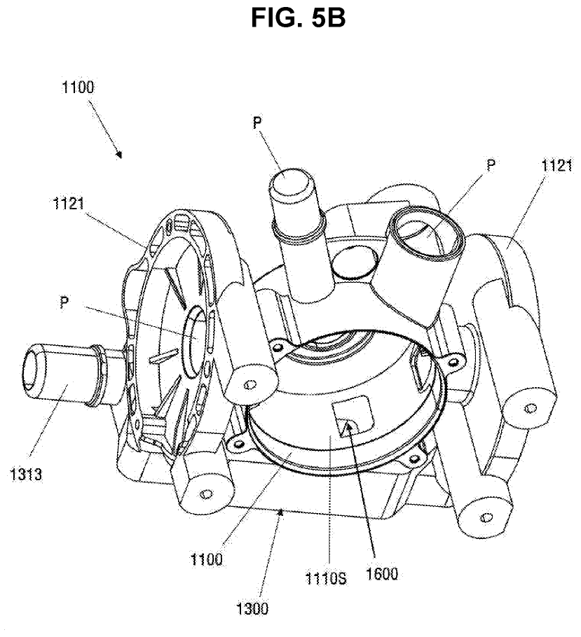

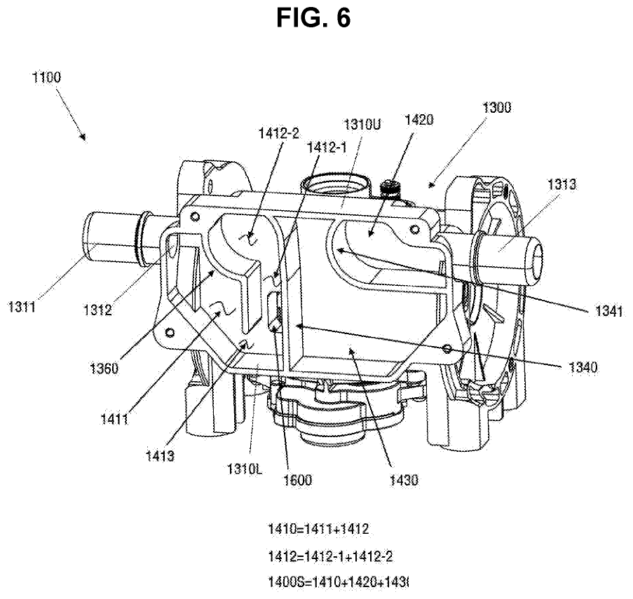

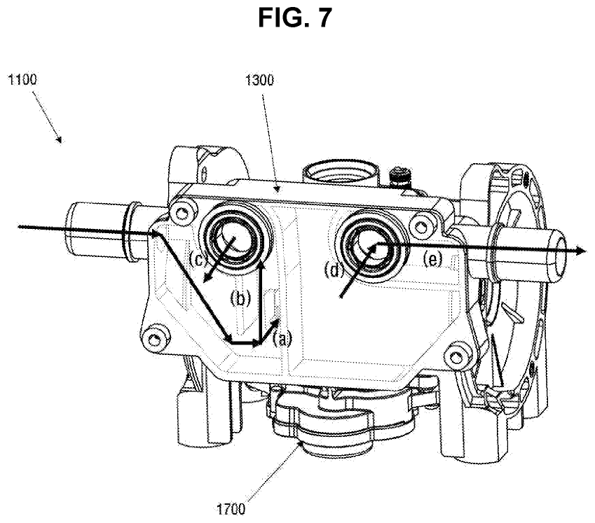

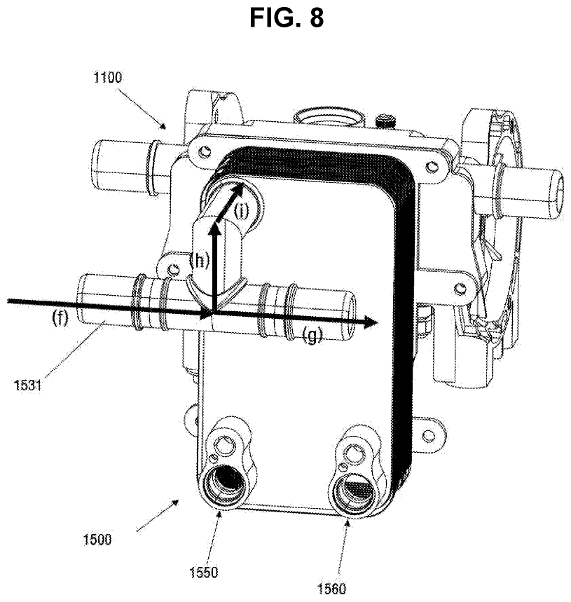

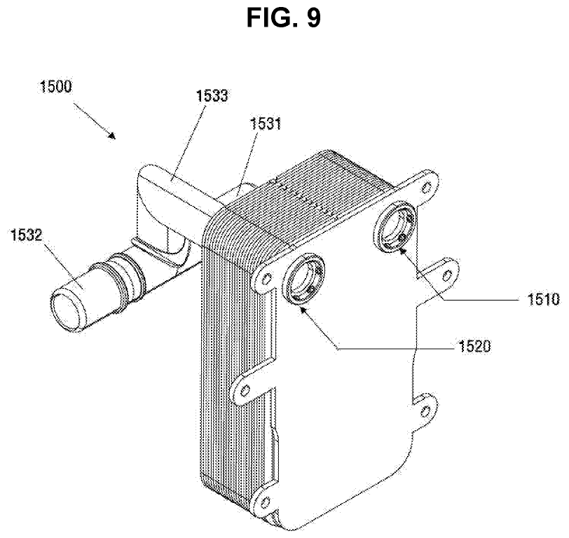

FIG. 1 is a perspective view of a coolant module according to an embodiment of the present disclosure. FIG. 2 is a plan view of the coolant module shown in FIG. 1. FIG. 3 is a perspective view showing a state in which a valve body, a manifold, and a heat exchanger are coupled in the coolant module according to the embodiment of the present disclosure. FIG. 4 is an exploded perspective view of the coolant module shown in FIG. 3. FIGS. 5A and 5B are perspective views showing a configuration in which the valve body and the manifold are integrally formed in the coolant module according to the embodiment of the present disclosure as viewed from different angles. FIG. 6 is a perspective view showing a state in which a manifold housing is coupled to the valve body shown in FIG. 4. FIG. 7 is a perspective view showing a state in which a manifold cover is coupled to the manifold housing shown in FIG. 6. FIG. 8 is a perspective view showing a state in which the heat exchanger is coupled to the manifold shown in FIG. 7. FIG. 9 is a perspective view of the heat exchanger shown in FIG. 8 as viewed from another angle. Hereinafter, a manifold-integrated coolant module 1000 according to an embodiment of the present disclosure will be described.

The manifold-integrated coolant module 1000 (hereinafter referred to as a coolant module) according to the embodiment of the present disclosure is equipment that is connected to a battery coolant line and an electric component coolant line for increase in temperature and cooling of a battery and electric components (e.g., a motor and an inverter) of a vehicle and supplies coolant to the battery and the electric components so that the coolant circulates therethrough.

The manifold-integrated coolant module 1000 according to the embodiment of the present disclosure includes a valve body 1100, a manifold 1300, and a heat exchanger 1500. The valve body 1100, the manifold 1300, and the heat exchanger 1500 are coupled in fluid communication with one another.

The valve body 1100 includes a valve housing 1110. The valve housing 1110 has a hollow cylindrical structure in which a rotor space 1110S for accommodating a valve rotor 1200 is defined and at least one port P is radially arranged along a circumference of the valve housing 1110. Each port P is a hole penetrating a side wall of the valve housing 1110, and coolant flows into and out of the rotor space 1110S through the port P.

The valve rotor 1200 is formed in a cylindrical shape. A plurality of communication holes 1201 corresponding to a plurality of ports P of the valve housing 1110 is formed in a circumference of the valve rotor 1200. At least one internal flow path is formed inside the valve rotor 1200 to connect some of the communication holes 1201 so that some of the plurality of ports P communicate with one another. Accordingly, as the valve rotor 1200 rotates within the valve housing 1110, some of the ports P of the valve housing 1110 are closed, and at least two ports P are connected to the internal flow path of the valve rotor 1200 to form a flow path through which coolant flows in and out. The manifold-integrated coolant module 1000 according to the embodiment may include a multi-port valve. For example, six ports P for inflow and outflow of coolant may be provided in the valve housing 1110.

In order to enable rotation of the valve rotor 1200, an actuator 1700 is mounted on a lower side of the valve body 1100, and a rotation shaft to which the actuator 1700 is coupled is provided at a center of the valve rotor 1200. Accordingly, if the actuator 1700 is driven, the valve rotor 1200 is rotated about the rotation shaft within the rotor space 1110S. Depending on a rotation amount of the valve rotor 1200, some of the plurality of ports P provided in a circumference of the valve housing 1110 are blocked from or connected to one another.

The coolant module 1000 according to the present disclosure further includes a support bracket 1800 configured to support the valve body 1100 upwardly. The coolant module 1000 may be positioned on and secured to a vehicle body by fixedly mounting the support bracket 1800 to the vehicle body.

A pair of flanges 1121 is provided at both sides of the valve housing 1110, respectively. In addition, a water pump (EWP) 1120 for circulating coolant is mounted to each flange 1121. In more detail, one flange 1121 may be disposed at a position corresponding to one of the ports P of the valve housing 1110, and the water pump 1120 may be mounted to a corresponding flange 1121 so as to be in fluid communication with the rotor space 1110S through the corresponding port P. The water pump 1120 functions to deliver coolant from the valve body 1100 to the outside. According to the present disclosure, two water pumps 1120 are included. One of the two water pumps 1120 may be a battery-side water pump 1120, and the other thereof may be an electric component-side water pump 1120. The battery-side water pump 1120 delivers coolant to the battery coolant line so that the coolant circulates along the battery coolant line to cool a battery mounted on the battery coolant line. The electric component-side water pump 1120 delivers the coolant to the electric component coolant line so that the coolant circulates along the electric component coolant line to cool electric components (PE) (e.g., a motor and an inverter) mounted on the electric component coolant line.

According to the present disclosure, the manifold 1300 is disposed on one side of the valve body 1100 and is integrally formed with the valve body 1100. The manifold 1300 may be referred to as a coolant manifold 1300. The manifold 1300 provides a flow path through which coolant flows and includes a structure to which a heat exchange component provided in the vehicle is mounted.

In a cooling system according to the related art, respective heat exchange components, such as a reservoir tank, a water pump, and a valve, are individually mounted in a vehicle. These respective components are connected to one another via hoses to form a circuit of the cooling system. In the cooling system having the above configuration, a plurality of pipes through which refrigerant and coolant flow is required, various types of valves for connection and branching of the pipes are mounted, and the pipes and the valves are connected to one another in a complicated manner. Accordingly, the overall thermal management system is complicated and increased in size, and mounting of the pipes and valves results in high manufacturing cost and increased weight.

In the manifold-integrated coolant module 1000 according to the present disclosure, the manifold 1300 is integrated with the coolant module, thereby providing a flow path in the coolant module 1000 and allowing a plurality of heat exchange components to be directly mounted to the coolant module 1000 through the manifold 1300. For example, the manifold 1300 and the valve body 1100 may be injection-molded together and provided as an integral structure.

The manifold 1300 according to the present disclosure includes a manifold housing 1310 and a manifold cover 1350.

The manifold housing 1310 includes a coolant flow space 1400S in which coolant is stored and flows. In more detail, the manifold housing 1310 includes the coolant flow space 1400S defined by a bottom surface and circumferential wall portions thereof, and a top surface corresponding to the bottom surface is provided as an open surface, on which the manifold cover 1350 to be described later is disposed. The manifold cover 1350 is sealingly coupled to the manifold housing 1310, thereby hermetically sealing the coolant flow space 1400S. In the present disclosure, for convenience of description regarding an orientation of the manifold 1300, an upper wall portion among the circumferential wall portions is referred to as an upper wall 1310U, a lower wall portion is referred to as a lower wall 1310L, and a wall portion connecting the upper wall 1310U to the lower wall 1310L is referred to as a side wall.

As shown in FIG. 6, a first partition wall 1340 and a second partition wall 1341 are provided in the coolant flow space 1400S of the manifold housing 1310. These partition walls extend to connect two different wall portions of the manifold housing 1310, thereby dividing the coolant flow space 1400S into a plurality of spaces. The first partition wall 1340 extends to connect the upper wall 1310U to the lower wall 1310L, thereby spatially separating a first space 1410 from the coolant flow space 1400S. In this case, the first space 1410 refers to a space defined between one side wall of the manifold housing 1310 and the first partition wall 1340. In addition, as shown in FIG. 6, the second partition wall 1341 extends to connect the upper wall 1310U to the other side wall, thereby spatially separating a second space 1420 from the coolant flow space 1400S. The second space 1420 refers to a space defined between the other side wall of the manifold housing 1310 and the second partition wall 1341. As will be described later, the first space 1410 provides a coolant flow path through which coolant is introduced from a manifold inlet port 1311 and the introduced coolant flows out to the valve housing 1110 through a communication hole 1600 or flows out to the heat exchanger 1500 through a first port 1351. In addition, the second space 1420 provides a coolant flow path through which coolant is introduced from the heat exchanger 1500 through a second port 1352 and the introduced coolant flows out to a manifold outlet port 1313. In this case, the first space 1410 and the second space 1420 are spatially separated from each other. In addition, a third space 1430 is defined between the first partition wall 1340 and the second partition wall 1341. The third space 1430 remains empty, and coolant does not flow therethrough. The manifold cover 1350 sealingly covers the open surface of the manifold housing 1310 such that the first space 1410, the second space 1420, and the third space 1430 described above are defined as independent compartments.

In some embodiments, the second partition wall 1341 may extend so as to be positioned at an upper portion of the coolant flow space 1400S. As will be described later, in some embodiments, the manifold 1300 may be coupled to the support bracket 1800 in an upright orientation. In this upright orientation structure, gravity affects introduction and discharge of coolant. The second space 1420 is a space in which coolant discharged from the heat exchanger 1500 is stored before being discharged to the manifold outlet port 1313 through an outlet hole 1314. In this case, the outlet hole 1314 may be disposed at an upper portion of the manifold housing 1310. However, if the outlet hole 1314 is disposed at an upper portion of the manifold housing 1310 and the second partition wall 1341 extends from a lower portion of the manifold 1300 to define the second space 1420, the coolant introduced into the second space 1420 stays on the bottom of the second space 1420 before flowing out through the outlet hole 1314. This structure hinders smooth circulation of the coolant. Therefore, in some embodiments, the second partition wall 1341 may be positioned at an upper portion of the first space 1410.

The manifold cover 1350 may cover the entirety of the open surface of the coolant flow space 1400S of the manifold housing 1310. To this end, the manifold cover 1350 is formed in a shape corresponding to the open surface of the coolant flow space 1400S of the manifold housing 1310. The manifold cover 1350 may be coupled to the open surface of the manifold housing 1310 through a hot plate welding method. For example, the manifold cover 1350 and the open surface of the manifold housing 1310 may be pressed by a hot plate so as to be heated, softened, and melted. If portions to be welded are sufficiently melted, the hot plate may be removed, and the manifold cover 1350 and the manifold housing 1310 may be pressed together and cooled so that the manifold cover 1350 and the manifold housing 1310 are welded to each other. This hot plate welding method provides an advantage in that a sealing member between the manifold housing and the manifold cover is unnecessary.

The manifold cover 1350 includes a first port 1351 and a second port 1352 to allow coolant to flow between the heat exchanger 1500 and the manifold 1300. The first port 1351 is provided at a position corresponding to a heat exchanger outlet space 1412-2 of the manifold housing 1310, and the second port 1352 is provided at a position corresponding to the second space 1420. This configuration will be described in detail later.

The manifold 1300 configured as described above includes a manifold inlet port 1311 and a manifold outlet port 1313 for introduction and discharge of coolant. An inlet hole 1312 and a manifold inlet port 1311 are provided on one side wall of the manifold housing 1310, and the manifold inlet port 1311 is in fluid communication with the first space 1410 through the inlet hole 1312. An outlet hole 1314 and a manifold outlet port 1313 are provided on the other side wall of the manifold housing 1310. The manifold outlet port 1313 is in fluid communication with the second space 1420 through the outlet hole 1314. As described above, because the first space 1410 is independently defined within the coolant flow space 1400S, coolant introduced into the first space 1410 through the manifold inlet port 1311 flows only within the first space 1410 and then flows out to the valve body 1100 or the heat exchanger 1500. Because the second space 1420 is also independently defined within the coolant flow space 1400S, coolant introduced into the second space 1420 from the heat exchanger 1500 through the second port 1352 flows only within the second space 1420 and then flows out to the manifold outlet port 1313.

As described above, the manifold 1300 and the valve body 1100 are coupled to be in fluid communication with each other. To this end, a communication hole 1600 is formed through the valve housing 1110 of the valve body 1100 and the manifold housing 1310 of the manifold 1300. For example, the communication hole 1600 may have a single tubular structure penetrating the valve housing 1110 and the manifold housing 1310. The communication hole 1600 may be formed in a straight tubular structure.

The communication hole 1600 may be formed in a bottom surface of the manifold housing 1310 that defines the first space 1410. As described above, coolant introduced into the first space 1410 of the manifold housing 1310 through the manifold inlet port 1311 may flow into the rotor space 1110S of the valve housing 1110 through the communication hole 1600. To this end, the communication hole 1600 is formed in the first space 1410 to allow coolant to flow from the first space 1410 to the rotor space 1110S.

According to the embodiment of the present disclosure, the communication hole 1600 may be oriented perpendicular to the bottom surface of the manifold housing 1310 and may extend toward the valve housing 1110. As described above, because the communication hole 1600 has a straight tubular structure and the communication hole 1600 is oriented perpendicular to the bottom surface of the manifold housing 1310, a flow distance of coolant between the manifold housing 1310 and the valve housing 1110 may be minimized. Accordingly, a flow direction of coolant in the first space 1410 of the manifold 1300 and a flow direction of coolant from the first space 1410 to the valve body 1100 are perpendicular to each other. The manifold 1300 according to the present disclosure is integrally formed with the valve body 1100. For example, the manifold 1300 and the valve body 1100 may be integrally manufactured through an injection molding method using an upper mold and a lower mold. As described above, the manifold 1300 and the valve body 1100 communicate with each other through the communication hole 1600. If the communication hole 1600 is oriented perpendicular to the bottom surface of the manifold housing 1310, manufacturing is facilitated as compared with an obliquely oriented structure. If the communication hole 1600 is oriented obliquely with respect to the bottom surface of the manifold housing 1310, an additional process is required to implement the oblique orientation. For example, the obliquely oriented structure may require a side core mold in addition to an upper mold and a lower mold. After the manifold 1300 and the valve body 1100 are integrally manufactured, the obliquely oriented communication hole 1600 is additionally formed using the side core mold. In contrast, according to the present disclosure in which the communication hole 1600 is oriented perpendicular to the bottom surface of the manifold housing 1310, an integral structure of the manifold 1300 and the valve body 1100 including the communication hole 1600 may be formed at once using an upper mold and a lower mold. Accordingly, an additional side core mold and an additional side core process are not required.

As shown in FIG. 6, a guide wall 1360 is provided in the first space 1410 of the manifold housing 1310. As described above, the communication hole 1600 is formed in a bottom surface of the manifold housing 1310 that defines the first space 1410. The guide wall 1360 is disposed between the inlet hole 1312 formed in one side of the manifold housing 1310 and the communication hole 1600 to block the inlet hole 1312 and the communication hole 1600 from each other. Unlike the first partition wall 1340 or the second partition wall 1341 described above, the guide wall 1360 does not partition the first space 1410 into two independent spaces, but functions to guide flow of coolant within the first space 1410. In more detail, the first space 1410 is divided into an inlet hole-side space 1411 and a communication hole-side space 1412 by the guide wall 1360. The inlet hole-side space 1411 and the communication hole-side space 1412 are not independently separated from each other, but are in fluid communication with each other. To this end, the guide wall 1360 extends from the upper wall 1310U of the manifold housing 1310 toward the lower wall 1310L of the manifold housing 1310, and an end of the guide wall 1360 is spaced a predetermined gap from the lower wall 1310L. Accordingly, a connection passage 1413 that fluidly connects the inlet hole-side space 1411 to the communication hole-side space 1412 is formed, and coolant moves from the inlet hole-side space 1411 to the communication hole-side space 1412 through the connection passage 1413. Coolant introduced into the inlet hole-side space 1411 through the inlet hole 1312 is blocked by the guide wall 1360 from flowing in a straight path toward the communication hole 1600, and flows along a bypass path to the communication hole-side space 1412 via the connection passage 1413.

The manifold-integrated coolant module 1000 according to the embodiment of the present disclosure may be configured such that the manifold 1300 is coupled to the support bracket 1800 in an upright orientation. For example, the manifold 1300 may be disposed in an upright orientation with respect to the support bracket 1800 so that the coolant flow space 1400S of the manifold 1300 is disposed in a vertical direction. In this upright orientation structure, the bottom surface of the manifold housing 1310 is disposed to face the valve housing 1110 of the valve body 1100, the upper wall 1310U of the manifold housing 1310 is disposed at an upper position, and the lower wall 1310L of the manifold housing 1310 is disposed at a lower position. In the upright orientation structure of the manifold, the aforementioned inlet hole 1312 is disposed at an upper portion of the manifold housing 1310, and the connection passage 1413 is disposed at a lower portion of the manifold housing 1310. Accordingly, coolant introduced into the inlet hole-side space 1411 through the inlet hole 1312 flows downward toward the connection passage 1413 disposed at a lower portion of the manifold housing 1310 and then flows into the communication hole-side space 1412 via the connection passage 1413.

The communication hole-side space 1412 may be divided into a valve outlet space 1412-1 and a heat exchanger outlet space 1412-2 in a coolant flow direction. The communication hole 1600 is disposed in the valve outlet space 1412-1, and the valve outlet space 1412-1 refers to a space from which coolant flows out to the valve body 1100 through the communication hole 1600. The first port 1351 is disposed in the heat exchanger outlet space 1412-2, and the heat exchanger outlet space 1412-2 refers to a space from which coolant flows out to the heat exchanger 1500 through the first port 1351 to be described later. According to the present disclosure, in the upright orientation structure of the manifold 1300, the valve outlet space 1412-1 is positioned below the heat exchanger outlet space 1412-2. For example, the communication hole 1600 may be disposed below the first port 1351 in the communication hole-side space 1412. Accordingly, coolant introduced into the communication hole-side space 1412 through the connection passage 1413 first flows out to the valve body 1100 through the communication hole 1600, and if the communication hole 1600 is blocked, the coolant may flow out to the heat exchanger 1500. This will be described in more detail below with reference to FIGS. 6 and 7.

As described above, the guide wall 1360 extends from the upper wall 1310U of the manifold housing 1310 toward the lower wall 1310L of the manifold housing 1310, and the manifold 1300 is disposed in an upright orientation with respect to the support bracket 1800. Accordingly, a coolant flow path extending in the vertical direction is defined in the communication hole-side space 1412. Coolant introduced into the communication hole-side space 1412 rises from a lower portion of the communication hole-side space 1412 to an upper portion of the communication hole-side space 1412 due to gravity. Accordingly, the valve outlet space 1412-1 is first filled with the coolant, and then the heat exchanger outlet space 1412-2 is filled with the coolant.

The communication hole 1600 is selectively opened or closed according to a rotational angle of the valve rotor 1200. The communication hole 1600 sequentially penetrates the bottom surface of the manifold housing 1310 and the valve housing 1110 and extends to the rotor space 1110S. The valve rotor 1200 is rotatably mounted in the rotor space 1110S, and ports provided in a circumference of the valve housing 1110 are selectively opened or closed according to a rotation amount of the valve rotor 1200. The communication hole 1600 is one of these ports. If the communication hole 1600 is not blocked by the valve rotor 1200, the rotor space 1110S communicates with the communication hole-side space 1412. In this case, coolant that has passed through the connection passage 1413 flows into the valve outlet space 1412-1, and if the level of the coolant reaches the communication hole 1600, the coolant flows out to the valve body 1100 through the communication hole 1600 (refer to (a) in FIG. 7). In this state, the coolant does not flow out to the heat exchanger 1500. If the communication hole 1600 is blocked by the valve rotor 1200, the coolant does not flow into the rotor space 1110S, but flows from the valve outlet space 1412-1 toward the heat exchanger outlet space 1412-2 (refer to (b) in FIG. 7). In this process, the valve outlet space 1412-1 is first filled with the coolant, and then the heat exchanger outlet space 1412-2 is filled with the coolant. If the level of the coolant reaches the first port 1351, the coolant flows out to the heat exchanger 1500 (refer to (c) in FIG. 7).

In order to implement the above-described coolant flow, in the upright orientation structure of the manifold 1300 according to the present disclosure, the communication hole 1600 is disposed below the first port 1351 in the communication hole-side space 1412. Because the valve outlet space 1412-1 is positioned below the heat exchanger outlet space 1412-2, the coolant may preferentially flow out to the valve body 1100 through the communication hole 1600. If the communication hole 1600 is blocked, the coolant may flow out to the heat exchanger 1500 through the first port 1351.

As described above, coolant introduced into the communication hole-side space 1412 may flow out to either the valve body 1100 or the heat exchanger 1500 depending on whether the communication hole 1600 is open or closed. This indicates that the configuration defined by the communication hole-side space 1412 and the communication hole 1600 functions as a T-fitting. For example, the communication hole-side space 1412 may define a coolant flow path, and the coolant flow path may be defined to extend in the vertical direction in the upright orientation structure of the manifold 1300. The communication hole 1600 having a tubular structure is disposed in the middle of the coolant flow path. Under such an arrangement condition, if the communication hole 1600 is in an open state, only a flow path through which the coolant flows into the valve body 1100 through the communication hole 1600 is established. Conversely, if the communication hole 1600 is in a closed state, only a flow path through which the coolant flows into the heat exchanger 1500 through the first port 1351 is established. This is because, in the upright orientation structure of the manifold 1300, coolant in the first space 1410 first reaches the communication hole 1600 due to gravity and then flows out to the rotor space 1110S of the valve body 1100 through the communication hole 1600 in an open state. According to this configuration, even if a separate T-shaped branch pipe 1530 is not provided between the manifold 1300 and the valve body 1100, a function of the T-shaped branch pipe 1530 may be achieved through the communication hole 1600, thereby providing a technical advantage in that the T-shaped branch pipe 1530 is omitted.

According to the present disclosure, the heat exchanger 1500 is disposed on one side of the manifold 1300, and the heat exchanger 1500 and the manifold 1300 are coupled to each other so as to be in fluid communication with each other. The heat exchanger 1500 may be a chiller.

In more detail, the heat exchanger 1500 includes a coolant inlet 1510 and a coolant outlet 1520. If the heat exchanger 1500 is coupled to one side of the manifold 1300, the coolant inlet 1510 and the coolant outlet 1520 are sealingly coupled to the first port 1351 and the second port 1352 of the manifold cover 1350, respectively. In order to implement sealed coupling, sealing members 1900 may be disposed between the coolant inlet 1510 and the first port 1351 and between the coolant outlet 1520 and the second port 1352.

The heat exchanger 1500 may include a plurality of first heat exchange plates and a plurality of second heat exchange plates, which are alternately stacked. The respective first heat exchange plates and the respective second heat exchange plates may extend in the same planar direction and may be stacked in a direction perpendicular to the planar direction. In such a structure, coolant flows through the first heat exchange plates, and refrigerant flows through the second heat exchange plates. Heat exchange may occur between refrigerant lines formed in the second heat exchange plates, through which the refrigerant flows, and coolant lines formed in the first heat exchange plates, through which the coolant flows.

A bottom cover plate of the heat exchanger 1500 includes a plurality of screw holes formed along edges of the bottom cover plate. The screw holes of the heat exchanger 1500 are aligned with screw holes of the manifold cover 1350 and screw holes of the manifold housing 1310, and screws are fastened into the screw holes so that the heat exchanger 1500 are fixedly coupled to the manifold cover 1350 and the manifold housing 1310.

As the manifold 1300 is disposed in an upright orientation with respect to the support bracket 1800, the heat exchanger 1500 is also coupled to the support bracket 1800 in an upright orientation. In this upright orientation structure, the bottom cover plate of the heat exchanger 1500 is disposed to face the manifold cover 1350, the coolant inlet 1510 and the coolant outlet 1520 are disposed at an upper position, and a refrigerant inlet port 1550 and a refrigerant outlet port 1560 are disposed at a lower position. According to this arrangement, the refrigerant and the coolant flow in opposite vertical directions inside the heat exchanger 1500.

The coolant is introduced into the heat exchanger 1500 through the first port 1351 and the coolant inlet 1510. As described above, after the coolant is introduced into the communication hole-side space 1412, if the communication hole 1600 is in a closed state, the coolant sequentially flows into the valve outlet space 1412-1 and the heat exchanger outlet space 1412-2, and then the level of the coolant rises. The coolant in the heat exchanger outlet space 1412-2 flows into the heat exchanger 1500 through the first port 1351 and the coolant inlet 1510 of the heat exchanger 1500 (refer to (c) in FIG. 7). Accordingly, only a coolant flow directed from the manifold 1300 toward the heat exchanger 1500 is formed in the first port 1351 and the coolant inlet 1510. The coolant introduced into the heat exchanger 1500 through the first port 1351 and the coolant inlet 1510 exchanges heat with the refrigerant while flowing through the heat exchanger 1500. The coolant that has undergone heat exchange is introduced back into the manifold 1300 through the coolant outlet 1520 of the heat exchanger 1500 and the second port 1352 (refer to (d) in FIG. 7). Because the second port 1352 is provided at a position corresponding to the second space 1420, the coolant that has undergone heat exchange flows into the second space 1420 of the manifold 1300. Accordingly, only a coolant flow directed from the heat exchanger 1500 toward the manifold 1300 is formed in the second port 1352 and the coolant outlet 1520. The coolant introduced into the second space 1420 is prevented from flowing into the third space 1430 by the second partition wall 1341 described above, and is discharged to the manifold outlet port 1313 through a discharge hole formed in the manifold housing 1310 (refer to (e) in FIG. 7). Due to the upright orientation of the heat exchanger 1500, the coolant inlet 1510 and the coolant outlet 1520 are positioned at an upper portion of the heat exchanger 1500, thereby establishing a U-shaped coolant flow inside the heat exchanger 1500.

The heat exchanger 1500 includes a refrigerant inlet port 1550 and a refrigerant outlet port 1560. Due to the upright orientation of the heat exchanger 1500, the refrigerant inlet port 1550 and the refrigerant outlet port 1560 are positioned at a lower portion of the heat exchanger 1500, as shown in FIG. 8. Accordingly, an inverted U-shaped refrigerant flow may be established inside the heat exchanger 1500 in a direction opposite the coolant flow.

With a configuration in which the coolant inlet and the coolant outlet are disposed at an upper portion of the heat exchanger 1500 and the refrigerant inlet port and the refrigerant outlet port are disposed at a lower portion of the heat exchanger 1500, accumulation of air within the upper portion of the heat exchanger 1500 may be mitigated, and deterioration in refrigerant oil circulation performance may be prevented.

In detail, if the coolant inlet and the coolant outlet are disposed at an upper portion of the heat exchanger 1500, air does not accumulate inside the chiller. In general, because gaps between the heat exchange plates in the stacking direction within the heat exchanger 1500 are very small, a pressure drop occurs inside the heat exchanger 1500. If the coolant inlet 1510 and the coolant outlet 1520 are positioned at a lower portion of the heat exchanger 1500, the coolant flows along an inverted U-shaped flow path in such a manner that the coolant is introduced at a lower side, flows upward and downward, and is then discharged outside at the lower side. In such a configuration, air may accumulate at a top of the inverted U-shaped flow path. In contrast, according to the present disclosure, because the coolant inlet 1510 and the coolant outlet 1520 are positioned at an upper portion of the heat exchanger 1500 to form a U-shaped flow path, accumulation of air within the heat exchanger 1500 may be reduced compared to the configuration in which the coolant flows along the inverted U-shaped flow path.

Furthermore, the configuration in which the refrigerant inlet port and the refrigerant outlet port are disposed at a lower portion of the heat exchanger provides an advantage in that refrigerant oil circulation performance is improved. If the refrigerant inlet port and the refrigerant outlet port are disposed at an upper portion of the heat exchanger, the low-pressure refrigerant outlet port is positioned at the top, making it difficult for the low-pressure oil to exit the outlet of the chiller, thereby deteriorating refrigerant oil circulation performance. In contrast, according to the present disclosure, because the refrigerant inlet port and the refrigerant outlet port are positioned at a lower portion of the heat exchanger 1500 to form an inverted U-shaped flow path, the low-pressure oil may easily exit the chiller through the refrigerant outlet port positioned at the lower portion, thereby preventing deterioration in refrigerant oil circulation performance.

The heat exchanger 1500 includes a T-shaped branch pipe 1530 for inflow and outflow of the coolant. The T-shaped branch pipe 1530 is integrally coupled to the heat exchanger 1500 by means of a central connection pipe 1540. The T-shaped branch pipe 1530 includes a flow path extending from a T-fitting inlet port 1531 to a T-fitting outlet port 1532 and a heat exchanger inlet pipe 1533 extending from a branch point in the middle of the flow path to the central connection pipe 1540. Depending on the mode, a flow path along which the coolant flows from the T-fitting inlet port 1531 to the T-fitting outlet port 1532 is established in the T-shaped branch pipe 1530, or a flow path along which the coolant flows from T-fitting inlet port 1531 to the heat exchanger through the heat exchanger inlet pipe 1533 is established in the T-shaped branch pipe 1530.

A reservoir tank T may be communicatively coupled to one port mounted in the valve housing 1110 of the valve body 1100. In the illustrated embodiment of the present disclosure, the reservoir tank T is mounted on an upper portion of the valve body 1100.

The present disclosure provides an advantage in that two T-fittings provided in the conventional coolant system are omitted. First, by implementing a T-fitting within the manifold, a separate T-fitting is omitted in the coolant pipe. In detail, the communication hole penetrating the manifold and the valve body is formed in the first space of the manifold. If the communication hole is open, coolant flowing into the communication hole-side space of the first space is directed to the valve body. If the communication hole is closed, the coolant bypasses the communication hole and flows into the heat exchanger. This coolant flow configuration substantially corresponds to a T-fitting. In addition, by modularizing the T-shaped branch pipe in the heat exchanger, a T-fitting that connects pipes to the chiller in the conventional coolant system may be omitted and replaced with the T-shaped branch pipe.

Furthermore, according to the present disclosure, the heat exchanger (chiller), the manifold, and the valve body are modularized, thereby providing an advantage in that four coolant pipes (hoses) are omitted. In detail, referring to FIGS. 7 and 8, by modularizing the manifold and the chiller, a pipe through which coolant flows from the manifold into the chiller (chiller IN pipe; refer to (c) in FIG. 7) and a pipe through which coolant is discharged from the chiller to the manifold (chiller OUT pipe; refer to (d) in FIG. 7) are incorporated into the modular structure. In addition, by modularizing the manifold and the valve body, a pipe through which coolant flows from the manifold into the valve body (valve IN pipe; refer to (a) in FIG. 7) is incorporated into the modular structure. Furthermore, by modularizing the T-shaped branch pipe in the chiller, a pipe through which coolant flows into the chiller through the T-shaped branch pipe (chiller IN pipe; refer to (i) in FIG. 8) is incorporated into the modular structure. Accordingly, two chiller IN pipes, one chiller OUT pipe, and one valve IN pipe are incorporated into the modular structure, thereby providing an advantage in that four pipes (hoses) provided in the conventional coolant system are omitted.

As is apparent from the above description, according to the embodiment of the present disclosure, by modularizing the valve body, the manifold, and the heat exchanger, assemblability of the overall coolant system may be improved, and the coolant system may be reduced in size.

Further, as the number of pipes is reduced, flow resistance of coolant may be reduced, and manufacturing costs and weights of components may be reduced.

In addition, by implementing a T-fitting within the manifold and providing a T-fitting (T-shaped branch pipe) in the heat exchanger, a separate T-fitting in the coolant pipe may be omitted.

The above is only one embodiment for implementing the manifold-integrated coolant module according to the disclosure, the disclosure is not limited to the above embodiment, and it is to be understood by those skilled in the art that various modifications can be made without departing from the gist of the disclosure as claimed in the following claims.

What is claimed is:

1. A manifold-integrated coolant module comprising:
a valve body including a valve housing having a rotor space defined therein and at least one port provided along a circumference of the valve housing;
a manifold disposed on one side of the valve body; and
a heat exchanger disposed on one side of the manifold,
wherein the heat exchanger, the manifold, and the valve body are coupled in fluid communication with one another, and
wherein the manifold is integrally formed with the valve body.

2. The manifold-integrated coolant module as claimed in claim 1, wherein the manifold comprises:
a manifold housing comprising a coolant flow space defined in the manifold housing; and
a manifold cover covering an open surface of the coolant flow space of the manifold housing,
wherein a first partition wall is provided in the coolant flow space to partition the coolant flow space into a first space defined between one side of the manifold housing and the first partition wall and a space defined between the first partition wall and the other side of the manifold housing, and
wherein the first space is an independent space.

3. The manifold-integrated coolant module as claimed in claim 2, wherein a second partition wall is provided in the space defined between the first partition wall and the other side of the manifold housing to partition the space defined between the first partition wall and the other side of the manifold housing into a second space defined between the other side of the manifold housing and the second partition wall and a third space defined between the first partition wall and the second partition wall, and
wherein the second space is an independent space.

4. The manifold-integrated coolant module as claimed in claim 2, wherein the manifold housing comprises a manifold inlet port provided at one side of the manifold housing, the manifold inlet port being in fluid communication with the first space through an inlet hole formed in one side of the manifold housing.

5. The manifold-integrated coolant module as claimed in claim 4, wherein the manifold housing comprises a manifold outlet port provided at the other side of the manifold housing, the manifold outlet port being in fluid communication with the second space through an outlet hole formed in the other side of the manifold housing.

6. The manifold-integrated coolant module as claimed in claim 5, further comprising a communication hole formed through the valve housing and the manifold housing to allow the valve body and the manifold to be in fluid communication with each other through the communication hole,
wherein the communication hole is oriented perpendicular to a bottom surface of the manifold housing and extends toward the valve housing.

7. The manifold-integrated coolant module as claimed in claim 6, wherein a guide wall is provided between the inlet hole and the communication hole in the first space to block a region between the inlet hole and the communication hole.

8. The manifold-integrated coolant module as claimed in claim 7, wherein the first space is divided into an inlet hole-side space and a communication hole-side space by the guide wall, and
wherein the guide wall extends from an upper wall of the manifold housing toward a lower wall of the manifold housing, and an end of the guide wall is spaced apart from the lower wall to define a connection passage fluidly connecting the inlet hole-side space to the communication hole-side space.

9. The manifold-integrated coolant module as claimed in claim 1, further comprising:
a valve rotor disposed in the rotor space;
an actuator mounted on a lower side of the valve body to drive the valve rotor; and
a support bracket supporting the valve body upwardly.

10. The manifold-integrated coolant module as claimed in claim 9, wherein the manifold is coupled to the support bracket in an upright orientation such that the coolant flow space is disposed in a vertical direction.

11. The manifold-integrated coolant module as claimed in claim 8, wherein the inlet hole and the outlet hole are disposed at an upper portion of the manifold housing and the connection passage is disposed at a lower portion of the manifold housing such that coolant introduced into the inlet hole-side space through the inlet hole flows downward toward the connection passage and coolant introduced into the communication hole-side space via the connection passage flows upward within the communication hole-side space.

12. The manifold-integrated coolant module as claimed in claim 8, wherein the communication hole-side space comprises a valve outlet space and a heat exchanger outlet space disposed in a coolant flow direction, the valve outlet space being positioned below the heat exchanger outlet space such that the coolant passes through the valve outlet space and then passes through the heat exchanger outlet space.

13. The manifold-integrated coolant module as claimed in claim 10, wherein the manifold cover sealingly covers an entirety of an open surface of the manifold housing and comprises a first port provided at a position corresponding to the heat exchanger outlet space,
wherein the heat exchanger comprises a coolant inlet and a coolant outlet, and
wherein, if the heat exchanger is coupled to one side of the manifold, the coolant inlet is coupled to the first port.

14. The manifold-integrated coolant module as claimed in claim 3, further comprising a second port provided at a position corresponding to the second space,
wherein the heat exchanger comprises a coolant inlet and a coolant outlet, and
wherein, if the heat exchanger is coupled to one side of the manifold, the coolant outlet is sealingly coupled to the second port.

15. The manifold-integrated coolant module as claimed in claim 12, wherein the communication hole is disposed in the valve outlet space, and
wherein the first port is disposed in the heat exchanger outlet space.

16. The manifold-integrated coolant module as claimed in claim 12, wherein opening/closing of the communication hole is controlled according to a rotational angle of the valve rotor,
wherein, if the communication hole is open, coolant having passed through the connection passage flows into the rotor space through the communication hole, and
wherein, if the communication hole is closed, the coolant flows into the valve outlet space and the heat exchanger outlet space and then flows into the coolant inlet of the heat exchanger through the first port.

17. The manifold-integrated coolant module as claimed in claim 1, wherein the heat exchanger comprises a T-shaped branch pipe for inflow and outflow of coolant, and
wherein the T-shaped branch pipe is integrally coupled to the heat exchanger by means of a central connection pipe.

18. The manifold-integrated coolant module as claimed in claim 1, further comprising a support bracket supporting the valve body upwardly,
wherein the heat exchanger is coupled to the support bracket in an upright orientation such that refrigerant and coolant flow in a vertical direction and comprises a refrigerant inlet port, a refrigerant outlet port, a coolant inlet, and a coolant outlet,
wherein the coolant outlet is disposed at an upper portion of the heat exchanger, and
wherein the refrigerant outlet port is disposed at a lower portion of the heat exchanger.
